(19) United States
(12) Patent Application Publication
(10) Pub. No.: US 2018/0206681 A1
(43) Pub. Date: Jul. 26, 2018

(54) Cutting Board Assembly

(71) Applicant: Magid Al Hussein, Revere, MA (US)

(72) Inventor: Magid Al Hussein, Revere, MA (US)

(21) Appl. No.: 15/412,632

(22) Filed: Jan. 23, 2017

(51) Int. Cl. A47J 47/00; B26B 29/02

(52) U.S. Cl. CPC A47J 47/005; B26B 29/025

(57) ABSTRACT

A cutting board assembly inhibiting cross contamination between food items includes a first cutting board. The first cutting board is selectively positioned on a support surface thereby facilitating a food item to be cut on the first cutting board. The first cutting board has a plurality of slots extending therein to insertably receive an associated one of a plurality of knives. A second cutting board is removably positioned on the first cutting board. A food item is selectively positioned on the second cutting board for cutting.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to cutting board devices and more particularly pertains to a new cutting board device for inhibiting cross contamination between food items.

### BRIEF SUMMARY OF THE INVENTION

An embodiment of the disclosure meets the needs presented above by generally comprising a first cutting board. The first cutting board is selectively positioned on a support surface thereby facilitating a food item to be cut on the first cutting board. The first cutting board has a plurality of slots extending therein to insertably receive an associated one of a plurality of knives. A second cutting board is removably positioned on the first cutting board. A food item is selectively positioned on the second cutting board for cutting.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a cutting board assembly according to an embodiment of the disclosure.

FIG. 2 is a left side view of an embodiment of the disclosure.

FIG. 3 is an exploded perspective view of an embodiment of the disclosure.

FIG. 4 is a perspective in-use view of an embodiment of the disclosure.

### DETAILED DESCRIPTION OF THE INVENTION

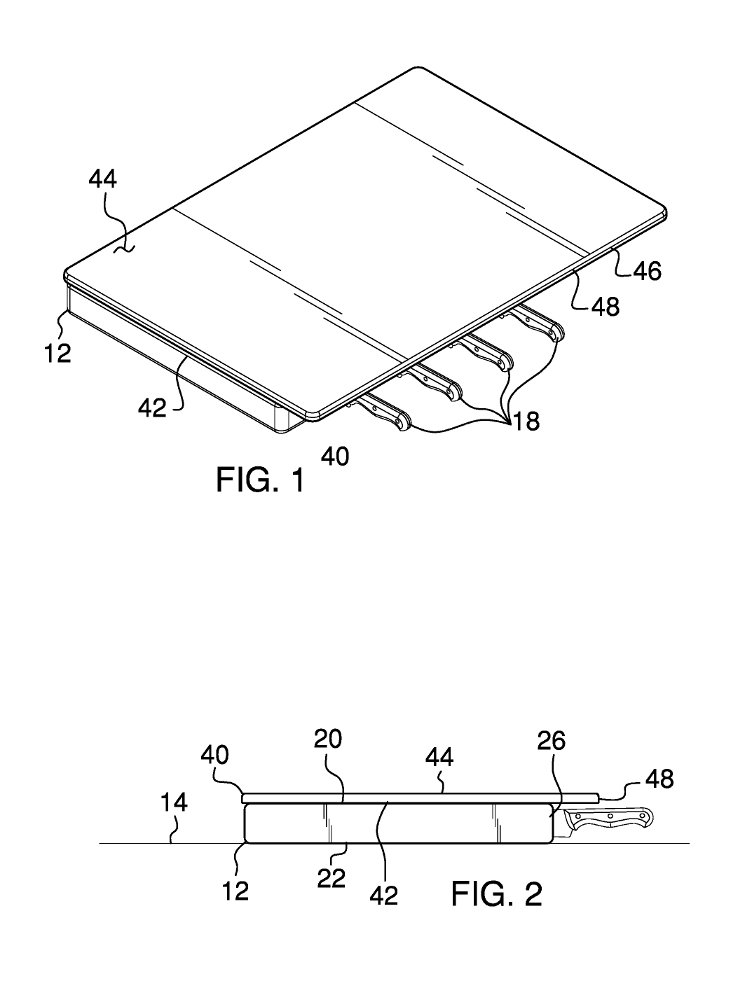

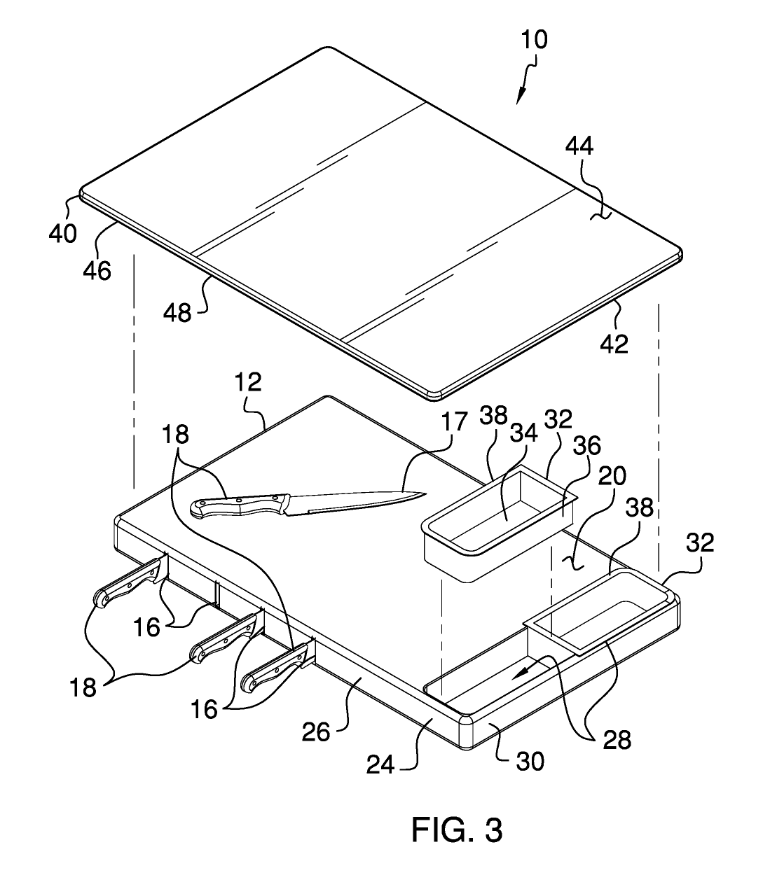

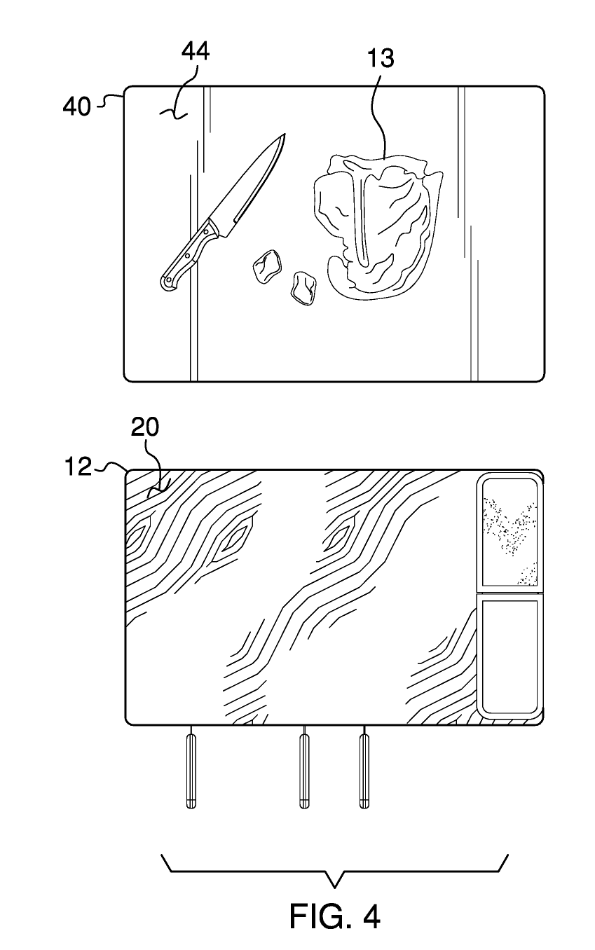

With reference now to the drawings, and in particular to FIGS. 1 through 6 thereof, a new cutting board device embodying the principles and concepts of an embodiment of the disclosure and generally designated by the reference numeral 10 will be described.

As best illustrated in FIGS. 1 through 6, the cutting board assembly 10 generally comprises a first cutting board 12 is that is selectively positioned on a support surface 14 thereby facilitating a food item 13 to be cut on the first cutting board 12. The support surface 14 may be a table top or the like. The first cutting board 12 has a plurality of slots 16 extending therein to insertably receive a blade 17 corresponding to an associated one of a plurality of knives 18. The plurality of knives 18 may include kitchen knives of any conventional design.

The first cutting board 12 has a first surface 20, a second surface 22 and a perimeter edge 24 extending therebetween. The perimeter edge 24 has a first side 26 and each of the slots 16 extends into the first side 26. The slots 16 are spaced apart from each other and are distributed on the first side 26. Moreover, the first cutting board 12 may be comprised of wood or other rigid material.

The first surface 20 has a plurality of wells 28 and each of the wells 28 extends toward the second surface 22. The first cutting board 12 has a first lateral side 30 and the wells 28 may be distributed along the first lateral side 30. The first surface 20 is selectively placed on the support surface 14 and the food item 13 is selectively placed on the second surface 22 for cutting. The food item 13 cut on the first cutting board 12 may be vegetables or other non-animal food item.

A plurality of containers 32 is provided and each of the containers 32 has a basal wall 34 and a peripheral wall 36 extending upwardly therefrom. Each of the containers 32 may contain food item 13 when the food item 13 is cut. The peripheral wall 36 has a distal edge 38 with respect to the basal wall 34 and each of the containers 32 is removably positioned in an associated one of the wells 28. The distal edge 38 corresponding to each of the containers 32 is aligned with the second surface 22 of the first cutting board 12 when each of the containers 32 is positioned in the associated well. Moreover, each of the containers 32 may be plastic food containers or the like such as Tupperware, Ziploc containers or other similar food container.

A second cutting board 40 is provided and the second cutting board 40 is removably positioned on the first cutting board 12. The second cutting board 40 may have a food item 13 positioned thereon for cutting. The second cutting board 40 has a primary surface 42, a secondary surface 44 and an outer edge 46 extending therebetween. The outer edge 46 has a primary side 48 and the second cutting board 40 may be comprised of plastic or other rigid material.

The primary side 48 extends beyond the first side 26 of the first cutting board 12 when the second cutting board 40 is positioned on the second cutting board 40. The primary surface 42 abuts the second surface 22 of the first cutting board 12 when the second cutting board 40 is positioned on the first cutting board 12. The food item 13 is positioned on the secondary surface 44 of the second cutting board 40 for cutting. The food item 13 cut on the second cutting board 40 may be meat or other non-vegetable food item 13. In this way the first 12 and second 40 cutting boards inhibit cross contamination between vegetable food items and animal food items.

In use, the first cutting board 12 is positioned on the support surface 14 and the meat is placed on the secondary surface 44 of the second cutting board 40 for cutting. A selected one of the knives 18 is removed from the associated slot 16 and the meat is cut. The second cutting board 40 is removed from the first cutting board 12 to facilitate the vegetable to be cut. The vegetable is placed on the first surface 20 of the first cutting board 12 for cutting. Additionally, the meat and the vegetable are urged into a selected one of the containers 32 when the meat and vegetables are cut. The selected container 32 is removed from the selected well for refrigeration, consumption or other use of the cut food item 13.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cutting board assembly being configured to store a plurality of knives, said assembly comprising:
a first cutting board being configured to be positioned on a support surface thereby facilitating a food item to be cut on said first cutting board, said first cutting board having a plurality of slots extending therein wherein each of said slots is configured to insertably receive an associated one of a plurality of knives; and
a second cutting board being removably positioned on said first cutting board wherein said second cutting board is configured to have a food item positioned thereon for cutting.

2. The assembly according to claim 1, wherein said first cutting board has a first surface, a second surface and a perimeter edge extending therebetween, said perimeter edge having a first side, each of said slots extending into said first side, said slots being spaced apart from each other and being distributed on said first side.

3. The assembly according to claim 2, further comprising said first surface having a plurality of wells, each of said wells extending toward said second surface, said first surface being configured to be positioned on the support surface, said second surface being configured to have the food item positioned thereon for cutting.

4. The assembly according to claim 3, further comprising a plurality of containers, each of said containers having a basal wall and a peripheral wall extending upwardly therefrom wherein each of said containers is configured to contain food items, said peripheral wall having a distal edge with respect to said basal wall, each of said containers being removably positioned in an associated one of said wells having said distal edge being aligned with said second surface of said first cutting board.

5. The assembly according to claim 1, wherein:
said first cutting board has a first surface and a first side; and
said second cutting board has a primary surface, a secondary surface and an outer edge extending therebetween, said outer edge having a primary side, said primary side extending beyond said first side of said first cutting board when said second cutting board is positioned on said second cutting board, said primary surface abutting said second surface of said first cutting board, said secondary surface being configured to have the food item positioned thereon.

6. A cutting board assembly being configured to store a plurality of knives, said assembly comprising:
a first cutting board being configured to be positioned on a support surface thereby facilitating a food item to be cut on said first cutting board, said first cutting board having a plurality of slots extending therein wherein each of said slots is configured to insertably receive an associated one of a plurality of knives, said first cutting board having a first surface, a second surface and a perimeter edge extending therebetween, said perimeter edge having a first side, each of said slots extending into said first side, said slots being spaced apart from each other and being distributed on said first side, said first surface having a plurality of wells, each of said wells extending toward said second surface, said first surface being configured to be positioned on the support surface, said second surface being configured to have the food item positioned thereon for cutting;
a plurality of containers, each of said containers having a basal wall and a peripheral wall extending upwardly therefrom wherein each of said containers is configured to contain food items, said peripheral wall having a distal edge with respect to said basal wall, each of said containers being removably positioned in an associated one of said wells having said distal edge being aligned with said second surface of said first cutting board; and
a second cutting board being removably positioned on said first cutting board wherein said second cutting board is configured to have a food item positioned thereon for cutting, said second cutting board having a primary surface, a secondary surface and an outer edge extending therebetween, said outer edge having a primary side, said primary side extending beyond said first side of said first cutting board when said second cutting board is positioned on said second cutting board, said primary surface abutting said second surface of said first cutting board, said secondary surface being configured to have the food item positioned thereon.
